(19) United States
(12) Patent Application Publication
(10) Pub. No.: US 2022/0392361 A1
(43) Pub. Date: Dec. 8, 2022

(54) LEARNING SYSTEM AND LEARNING METHOD

(71) Applicants: Kohei TANAKA, Tokyo (JP); Society5.0 LLC, Tokyo (JP)

(72) Inventor: Kohei TANAKA, Tokyo (JP)

(73) Assignee: Society5.0 LLC, Tokyo (JP)

(21) Appl. No.: 17/826,407

(22) Filed: May 27, 2022

(30) Foreign Application Priority Data
May 28, 2021 (JP) 2021-090361

(51) Int. Cl. G09B 5/02

(52) U.S. Cl. CPC G09B 5/02; G09B 19/003

(57) ABSTRACT

To provide a learning system capable of more effectively learning a learning object.

A learning system that includes at least a wearable terminal to be worn by a learner and is directed to learning of a learning object through a practice, the learning system comprising: a learning program executer that executes a learning program that prompts a learner to conduct a practice for learning about a learning object; and a practice information acquisitor that acquires image information and/or voice information regarding a state or a result of the practice by the learner during execution of the learning program by an imaging function and/or a voice acquisition function provided in the wearable terminal.

### CROSS REFERENCE TO RELATED APPLICATION

The present disclosure relates to subject matter contained in Japanese Patent Application No. 2021-090361, filed on May 28, 2021, the disclosure of which is expressly incorporated herein by reference in its entirety.

### TECHNICAL FIELD

The present invention relates to learning system and learning method by utilizing a wearable terminal.

### BACKGROUND ART

In recent years, augmented reality (AR) technology has attracted attention. Since the AR technology can present additional information superimposed on the real space visually recognized by the user, when the AR technology is applied to a wearable terminal, information can be confirmed without stopping manual work. For this reason, utilization of the AR technology in various fields is expected.

For example, an information providing system that provides information necessary for task execution to a user who is a medical worker at a medical site has been disclosed (see Patent Literature 1). During execution of a medical task, it is possible to confirm information regarding a necessary medical device in a hands-free manner without interrupting work such as a necessary operation. In addition, by using the wearable terminal, it is possible to perform an operation or the like while maintaining cleanliness without touching an operation manual of paper or the like.

Such information for operating the medical device is important not only for medical workers but also for learners who need to start learning the operation of the medical device. However, an object of Patent Literature 1 is to provide information for medical workers, and application for learners who learn operation of medical devices is not considered.

Furthermore, for example, a work process learning support system is disclosed as use of a wearable terminal utilizing the AR technology at a learning site (see Patent Document 2). However, this work process learning support system does not involve a method for assessing whether the operation of a learner is correct, and further improvement for the learner has been required.

### CITATION LIST

### Patent Literature

Patent Literature 1: JP 2018-132889 A
Patent Literature 2: JP 2016-062026 A

### SUMMARY OF INVENTION

### Technical Problem

The present invention has been made to solve such a problem. That is, an object of the present invention is to provide a learning system capable of more effectively learning a learning object.

### Solution to Problem

According to the present invention, the above object can be achieved by the following.

[1] A learning system that includes at least a wearable terminal to be worn by a learner and is directed to learning of a learning object through a practice, the learning system comprising:

a learning program executer that executes a learning program that prompts a learner to conduct a practice for learning about a learning object; and

a practice information acquisitor that acquires image information and/or voice information regarding a state or a result of the practice by the learner during execution of the learning program by an imaging function and/or a voice acquisition function provided in the wearable terminal.

[2] The learning system according to [1], further comprising:

an assessor that assesses the state or the result of the practice by the learner based on the image information or the voice information regarding the acquired state or result of the practice.

[3] The learning system according to [2], further comprising:

an outputter that outputs a learning item that requires further learning in accordance with a result of assessment by the assessor.

[4] The learning system according to any one of [1] to [3], wherein the learning object is a method of using a device or a method of executing manipulation.
[5] The learning system according to any one of [1] to [4], further comprising:

an input operation acquisitor that acquires image information or voice information regarding a motion of the learner during execution of the learning program by the imaging function or the voice acquisition function provided in the wearable terminal; and

an input executer that executes an input for progress of the learning program in accordance with the acquired image information or voice information regarding the motion of the learner.

[6] The learning system according to any one of [2] to [5], wherein the assessor assesses the state or the result of the practice by the learner based on a time from a start to an end of the practice by the learner and the image information or the voice information regarding the acquired state or result of the practice.
[7] The learning system according to any one of [2] to [6], wherein the assessor outputs learning attainment, comprehension of the learning object, and/or a skill level to the learning object as the state or the result of the practice by the learner.
[8] The learning system according to any one of [1] to [7], wherein the practice information acquisitor acquires image/moving image information regarding the state or the result of the practice, the learning system further comprising:

a player that plays the image/moving image and/or the voice based on the acquired image/moving image information and/or the voice information.

[9] The learning system according to any one of [1] to [8], further comprising:

an environmental information measurer that measures environmental information of a space in which the learner is learning, wherein the learning program executer executes a learning program according to a measured environment.

[10] The learning system according to any one of [1] to [9], further comprising a computer device operated by a leader, wherein

the computer device is capable of communication connection with the wearable terminal worn by the learner.

[11] A learning method executed in a learning system that includes at least a wearable terminal to be worn by a learner and is directed to learning of a learning object through a practice, the learning method comprising:

executing a learning program that prompts a learner to conduct a practice for learning about a learning object; and

acquiring image information and/or voice information regarding a state or a result of the practice by the learner during execution of the learning program by an imaging function and/or a voice acquisition function provided in the wearable terminal.

### Advantageous Effects of Invention

According to the present invention, it is possible to provide a learning system capable of more effectively learning a learning object.

### BRIEF DESCRIPTION OF DRAWINGS

FIG. 1 is a block diagram illustrating a configuration of a learning system according to the embodiment of the present invention.

FIG. 2 is a block diagram illustrating a configuration of the server device according to the embodiment of the present invention.

FIG. 3 is a block diagram illustrating a configuration of the learner terminal 1 according to the embodiment of the present invention.

FIG. 4 is a diagram illustrating a flowchart of the list data display processing according to the embodiment of the present invention.

FIGS. 5A and 5B are schematic diagrams of an example of a display screen of the learner terminal according to the embodiment of the present invention.

FIG. 6 is a diagram illustrating a flowchart of the learning program execution start processing according to the embodiment of the present invention.

FIG. 7 is a schematic diagram of an example of the learning program displayed on the learner terminal according to the embodiment of the present invention.

FIG. 8 is a schematic diagram illustrating an example of the display screen of the learner terminal according to the embodiment of the present invention.

FIG. 9 is a diagram illustrating a flowchart of the learning program execution processing according to the embodiment of the present invention.

FIGS. 10A and 10B are schematic diagrams illustrating an example of the assessment result displayed on the learner terminal according to the embodiment of the present invention.

### DESCRIPTION OF EMBODIMENTS

Hereinafter, an embodiment of the present invention will be described, but the present invention is not limited to the following embodiment unless it is contrary to the gist of the present invention. Hereinafter, the description regarding effects is an aspect of the effects of the embodiment of the present invention and is not limited to the description herein.

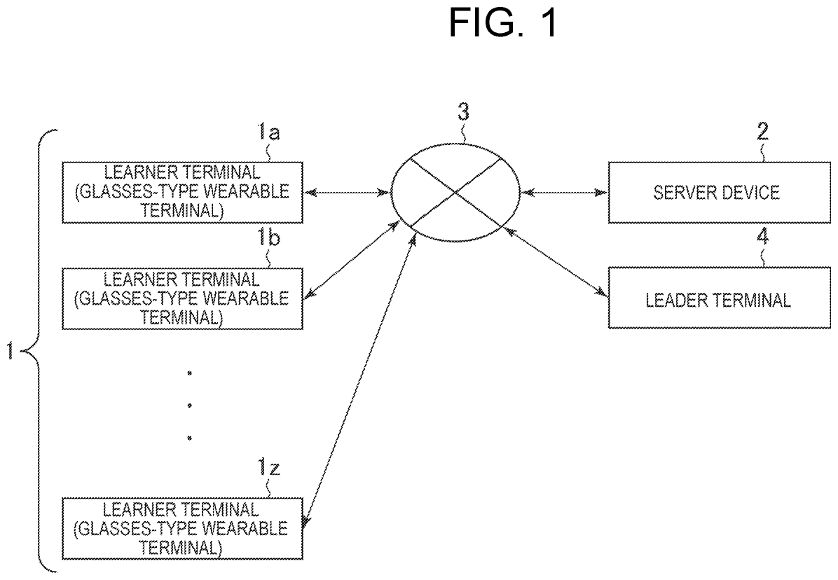

FIG. 1 is a block diagram illustrating a configuration of a learning system according to the embodiment of the present invention. As illustrated, the learning system includes a learner terminal 1, a server device 2, and a communication network 3. The learning system may include a plurality of learner terminals 1 (learner terminal 1a, 1b, . . . 1z) used by a plurality of learners. It is preferable that a plurality of learners can use the learner terminals 1 at the same time. Furthermore, the learner terminal 1 is a wearable terminal worn by a learner. Furthermore, the learning system may include a leader terminal 4 or may include a plurality of leader terminals 4. The server device 2 can be communicably connected to another computer device, that is, the learner terminal 1 or the leader terminal 4 via the communication network 3.

The leader terminal 4 is not particularly limited as long as it is a computer device having a display screen and an input unit. The leader terminal 4 may be a stationary type or may be similar to a wearable terminal worn by the learner. Examples of the learner terminal 4 include a conventional mobile phone, a tablet terminal, a smartphone, a desktop/notebook personal computer, and the like in addition to a glasses-type wearable terminal, a face shield-type wearable terminal, and a wristwatch-type wearable terminal. In the case of the wearable terminal, it suffices if images and/or moving images output from the terminal are displayed and the learner can visually recognize them, and the wearable terminal may be a glasses-type wearable terminal or a wearable terminal other than the glasses-type wearable terminal. Furthermore, the learner terminal 4 may be a speaker terminal compatible with interactive voice operation having an AI function.

The learning system according to the embodiment of the present invention provides a learner with information for learning about a learning object at a learning site. First, the learner wears the learner terminal 1, which is a wearable terminal. A voice is output and an image is displayed from the learner terminal 1 according to a learning program that is a learning object to be learned by the learner. The learner conducts a practice according to the output voice and the displayed image. Then, the learner terminal 1 acquires practice information during the practice conducted by the learner. The practice information is an image, a moving image, a voice, or the like. The practice information acquired by the learner terminal 1 is transmitted to the server device 2. The server device 2 receives the practice information and stores the practice information. On the basis of the stored practice information, the server device 2 analyzes the practice information of the learner and assesses the practice conducted by the learner. Furthermore, the stored practice information can be played by the learner terminal 1 or the leader terminal 4.

As a result, the learner can learn about the learning object by conducting the practice according to the learning program output from the learner terminal 1. Since the learning program is output by a voice, displayed by images, and/or displayed by moving images from the learner terminal 1, even when learning is performed for the first time on the learning object, it is possible to easily conduct the practice while confirming the actual device according to the learning program. In addition, it is possible to quickly confirm the assessment or review the practice conducted by him/herself.

Note that, here, the “learner” in the learning site is a student, a schoolchild, a trainee, a course participant, or the like who needs to learn about the learning object, and the “learner” may be of any age or gender. The “learning object” is not particularly limited, but is, for example, a method of using or operating a device, a method of executing manipulation, or the like. The “learning program” prompts the learner to conduct a practice for learning about a learning object, and includes one or more learning items. The “learning items” are items necessary for learning a learning object. The learning items include information such as texts, voices, images, and/or moving images. For example, a learning program for a method of using a certain device includes learning items such as preparation of the device, assembly of the device, and operation of the device. Furthermore, the learning items may include, for example, a question asking basic knowledge regarding the device or knowledge regarding the device such as “What to do if the device fails?”. In addition, the “device” in the present specification includes concepts such as a machine, an appliance, an apparatus, equipment, and an instrument. The “instrument” includes concepts such as a tool, a gear, and a jig.

### [Server Device]

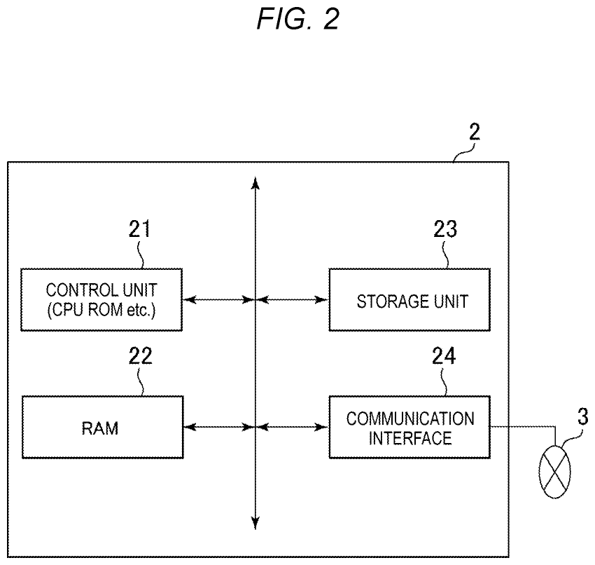

FIG. 2 is a block diagram illustrating a configuration of the server device according to the embodiment of the present invention. The server device 2 includes at least a control unit 21, a RAM 22, a storage unit 23, and a communication interface 24, which are connected by an internal bus.

The control unit 21 includes a CPU and a ROM, executes a program stored in the storage unit 23, and controls the server device 2. In addition, the control unit 21 includes an internal timer that clocks time. The RAM 22 is a work area of the control unit 21. The storage unit 23 is a storage area for storing programs and data. The control unit 21 reads the programs and data from the RAM 22, and performs program execution processing on the basis of information or the like received from the learner terminal 1.

### [Learner Terminal]

The learner terminal 1 is a glasses-type wearable computer such as smart glasses having a display unit, a head mounted display, or the like. For example, the learner terminal 1 is worn on the head of the learner to cover the front of the eyes and the face, and includes a lens and a display that do not block the field of view. At this time, the lens and the display of the learner terminal 1 may be arranged at least in front of one eye. That is, a glass such as an eyeglass for one eye may be used as long as stability during wearing is guaranteed. It is conceivable that the learner uses the learner terminal 1 while performing an operation such as turning up, down, left, and right in the practice of the learning program. Therefore, it is preferable the leaner terminal 1 has stability of wearing so that the learner terminal 1 worn during the practice does not fall. In addition, in order not to hinder the practice, it is preferable that the leaner terminal 1 be light weight and cause no discomfort by wearing.

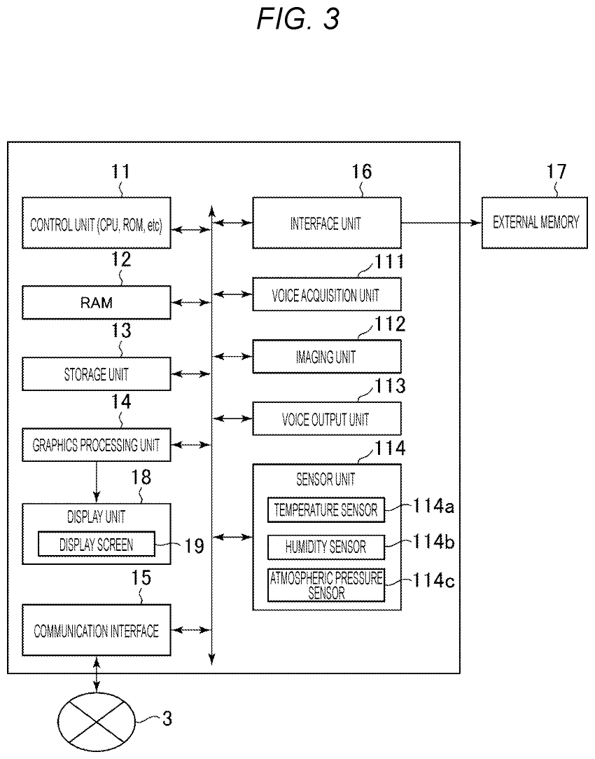

FIG. 3 is a block diagram illustrating a configuration of the learner terminal 1 according to the embodiment of the present invention. The learner terminal 1 includes a control unit 11, a RAM 12, a storage unit 13, a graphics processing unit 14, a communication interface 15, an interface unit 16, a display unit 18, a voice acquisition unit 111, an imaging unit 112, and a voice output unit 113, which are connected by an internal bus. Furthermore, the learner terminal 1 may include a sensor unit 114. The sensor unit 114 includes various sensors such as an atmospheric temperature sensor 114a, a humidity sensor 114b, an atmospheric pressure sensor 114c, a gyro sensor, and an acceleration sensor.

The control unit 11 includes a CPU and a ROM. The control unit 11 executes programs stored in the storage unit 13 and controls the learner terminal 1. The RAM 12 is a work area of the control unit 11. The storage unit 13 is a storage area for storing programs and data. The control unit 11 outputs a drawing command to the graphics processing unit 14 by processing the programs and data loaded in the RAM 12.

The graphics processing unit 14 is connected to the display unit 18. The display unit 18 has a display screen 19. When the control unit 11 outputs the drawing command to the graphics processing unit 14, the graphics processing unit 14 outputs a video signal for displaying an image on the display screen 19.

The communication interface 15 can be connected to the communication network 3 wirelessly or by wire, and can transmit and receive data to and from the server device 2 or the leader terminal 4 via the communication network 3. As a result, the learner terminal 1 can perform remote operation in addition to indoor operation. That is, the learner terminal 1 can be used not only indoors such as a classroom but also at the home of the learner or outdoors. Data received via the communication interface 15 is loaded into the RAM 12, and arithmetic processing is performed by the control unit 11. An external memory 17 (for example, an SD card or the like) is connected to the interface unit 16.

The voice acquisition unit 111 acquires a voice uttered by the learner wearing the learner terminal 1. The voice acquisition unit 111 has a function of recognizing an uttered voice of the learner acquired by a microphone or the like and extracting a specific signal. The voice acquired by the voice acquisition unit 111 is, for example, an operation signal for executing each operation such as an operation of starting and ending activation of the learning program, an operation of changing the display position or the display size of characters or images displayed on the display screen 19, an operation of selecting the learning program or the learning items, an operation of starting and ending the practice, and an operation of changing the volume of the output voice. Furthermore, the voice acquired by the voice acquisition unit 111 is, for example, a signal for assessing the state or result of the practice. Furthermore, it is possible to specify requested information by voice. Specifically, in a case where a specific learning item is requested, which learning object is requested and which learning item is requested can be specified by voice. Furthermore, the voice acquisition unit 111 can acquire sound of the environment around the learner terminal 1. For example, the voice acquisition unit 111 may include an internal microphone that acquires the voice of the learner and an external microphone that acquires the voice of the surrounding environment.

The imaging unit 112 images a range that can be visually recognized by the learner through the learner terminal 1. The imaging unit 112 is, for example, a built-in camera of the learner terminal 1. Preferably, the imaging unit 112 is provided such that the line-of-sight direction of the learner and the visual axis direction of the imaging unit 112 are substantially parallel when the learner wears the learner terminal 1. The voice output unit 113 outputs various voice information. The output voice information can be heard by the learner wearing the learner terminal 1. For example, the voice output unit 113 is a speaker, and may use a headphone, an earphone, a bone conduction earphone, or the like. Furthermore, for example, the voice output unit 113 outputs a voice of list data to be described later, outputs voice information included in the learning item, and outputs voice information included in an assessment result.

### [Leader Terminal]

The leader terminal 4 has a configuration similar to that of the server device 2, and includes, for example, a control unit, a RAM, a storage unit, a graphics processing unit, a communication interface, and an input unit, which are connected by an internal bus. Furthermore, the leader terminal 4 may have a configuration similar to that of the learner terminal 1.

Processing of the learning system according to the embodiment of the present invention will be described in the order of list data display processing, learning program execution start processing, and learning program execution processing. Note that, in the following description, it is mainly assumed that a learning object is a method of operating a medical device. In addition, the order of processes constituting the flowchart described below may be a random order as long as there is no contradiction or inconsistency in the processing content.

### [List Data Display Processing]

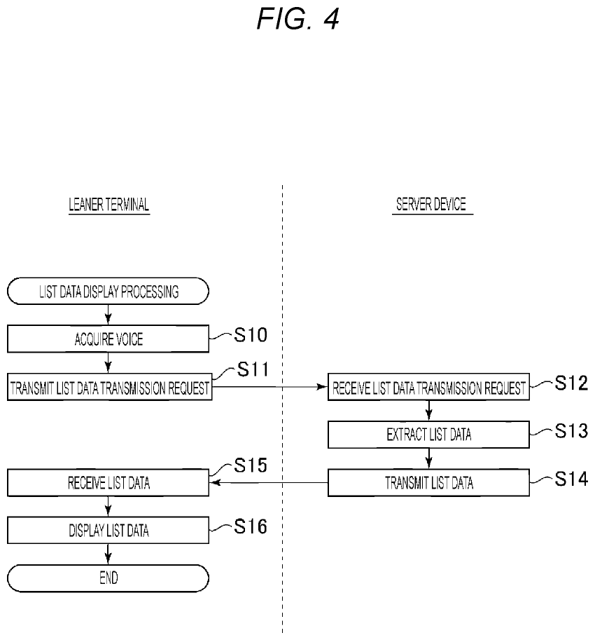

First, the list data display processing will be described. FIG. 4 is a diagram illustrating a flowchart of the list data display processing according to the embodiment of the present invention. The learner terminal 1 worn by the learner acquires a voice requesting the list data of the learning program of the learning object by the voice acquisition unit 111 (step S10). The learning program displayed as the list data may be a learning program that can be specified by the acquired voice, or may be a learning program related to a medical device or the like existing in a range visible from the learner terminal 1.

A list data transmission request is transmitted from the learner terminal 1 to the server device 2 (step S11), and the server device 2 receives the list data transmission request (step S12). The list data transmission request includes voice information of a learner who requests list data of a specific learning program and image information regarding a medical device present in a range visible from the learner terminal 1. The voice of the learner is acquired by the voice acquisition unit 111, and the image regarding the medical device is acquired by the imaging unit 112. The imaging unit 112 is provided such that the line-of-sight direction of the learner is substantially parallel to the visual axis direction of the imaging unit 112 when the learner wears the learner terminal 1. Therefore, the imaging unit 112 can image a range that can be visually recognized by the learner through the learner terminal 1.

The server device 2 extracts the list data on the basis of the received list data transmission request (step S13). The extracted list data is transmitted from the server device 2 to the learner terminal 1 (step S14). The learner terminal 1 receives the list data (step S15) and displays the list data (step S16).

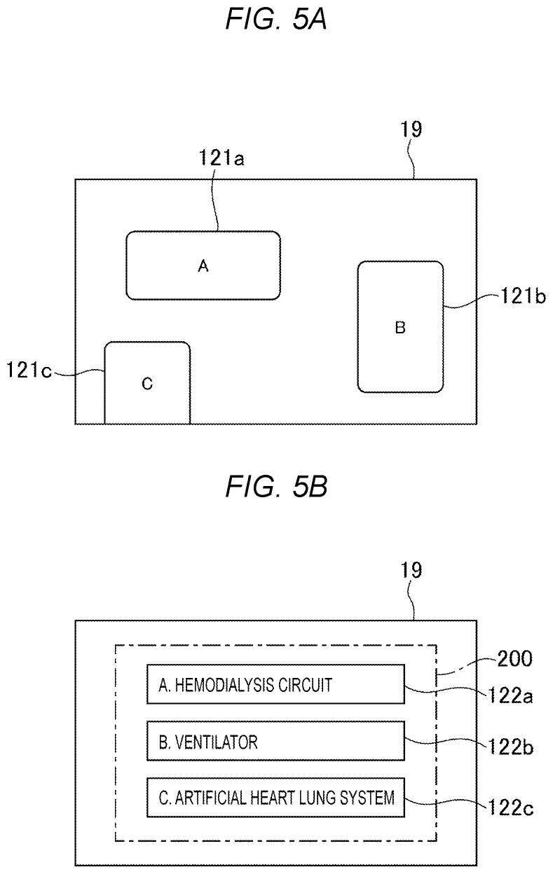

Here, FIG. 5A illustrates a schematic diagram of an example of a display screen of the learner terminal 1 according to the embodiment of the present invention. The learner wearing the learner terminal 1 visually recognizes medical devices 121a, 121b, and 121c through the display screen. When the voice requesting the list data of the learning program of the learning object is acquired by the voice acquisition unit 111 in step S10, the image information is acquired by the imaging unit 112 of the learner terminal 1. The learning program corresponding to each of the medical devices 121a, 121b, and 121c is stored in advance in the learner terminal 1 or the server device 2. In order to extract a learning program corresponding to each medical device or the like from the acquired image information, specific identification information is preferably attached to the medical devices 121a, 121b, and 121c. For example, the identification information such as a specific mark or a QR code (registered trademark) may be attached. In addition, the medical devices 121a, 121b, and 121c may be image-recognized from their shapes, colors, and the like by using artificial intelligence on the basis of the acquired image information.

FIG. 5B illustrates a schematic diagram of an example of list data displayed on the learner terminal 1. In a case where the image information of the medical devices 121a, 121b, and 121c is transmitted in step S11, list data of learning programs 122a, 122b, and 122c of the medical devices and the like respectively corresponding to the medical devices 121a, 121b, and 121c is displayed on the display screen 19 in step S16. The list data of the learning programs 122a, 122b, and 122c is displayed in a display area 200 on the display screen 19.

Through the processes of steps S10 to S16, the learner can display the list data of the learning program of the medical device or the like existing in the visible range. Here, the list data of the learning program of the medical device in the visible range is displayed, but the list data of the learning program of the medical device or the like that is specified by the voice of the learner and does not exist in the visible range may be displayed. In addition, the list data display processing may be repeated a plurality of times to display the list data of the learning items included in the learning program of the list data, or a learning program may be selected from the list data and the selected learning program may proceed to the learning program execution start processing described later. For example, in FIG. 5B, the learning program 122a such as a medical device may be selected and list data of learning items included in the learning program 122a may be displayed, or the processing may proceed to the learning program execution start processing described later.

### [Learning Program Execution Start Processing]

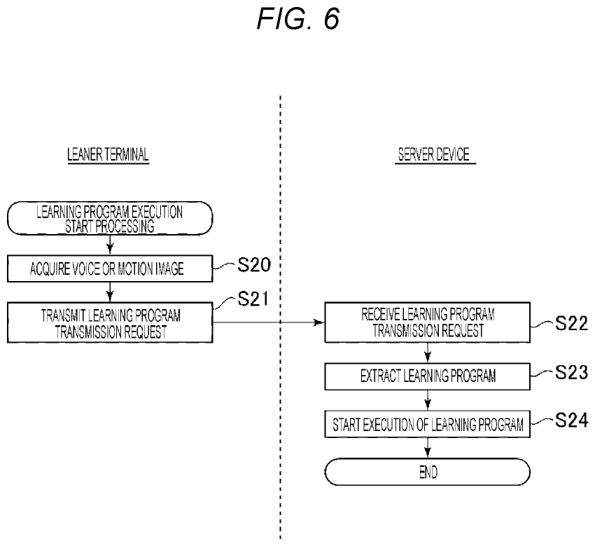

Next, the learning program execution start processing will be described. FIG. 6 is a diagram illustrating a flowchart of the learning program execution start processing according to the embodiment of the present invention. First, the learner terminal 1 acquires a voice uttered by the learner or a motion image through the voice acquisition unit 111 or the imaging unit 112 (step S20). A learning program transmission request is transmitted from the learner terminal 1 to the server device 2 (step S21), and the server device 2 receives the learning program transmission request (step S22). The server device 2 extracts the learning program on the basis of the received learning program transmission request (step S23). In the server device 2, execution of the learning program is started (step S24).

In the extraction of the learning program in step S23, when the execution of the learning program is the second time or later, the learning program corresponding to the learner can be extracted. For example, it is possible to extract a learning program with more detailed explanations or a learning program having many images/moving images by artificial intelligence according to a learning tendency of the learner and a state or result of the practice during learning by the learner. In addition, also at the time of execution of the first learning program, the learner can request a favorite learning program such as a learning program with many images or a learning program with many texts at the time of the learning program transmission request. Furthermore, for example, the learning program to be extracted may be changed according to attainment, comprehension, or a skill level of the learner to be described later. As the attainment, the comprehension, or the skill level of the learner increase, it is possible to reduce information to be displayed and voice to be output. In the case of a learning program including a plurality of learning items, the number of the learning items can be increased or decreased. As a result, a learning program suitable for the learner can be provided, and the learning object can be efficiently learned.

The learning program started to be executed in step S24 transmits an instruction (also referred to as a learning item) for a practice from the server device 2 to the learner terminal 1 in the learning program execution processing to be described later, and the learning item is executed in the learner terminal 1. The learning item received by the learner terminal 1 may be played after completion of reception or may be streamed. The learning items include information such as texts, voices, images, and/or moving images. The voices are output from the voice output unit 113, and the texts, the images, and the moving images are output to the display screen 19 of the display unit 18. Through the processes of steps S20 to S24, the learner can perform a practice related to the operation of the selected medical device according to the played learning program. Note that the processes in steps S22 to 24 may be performed by the learner terminal 1.

In a case where a plurality of learning items is included in the executed learning program, the learner terminal 1 can switch the learning items by acquiring a voice uttered by the learner or a motion image through the voice acquisition unit 111 or the imaging unit 112. The learning item is preferably played until the entire learning item included in the learning program is completed. In addition, it is also possible to play only the learning item selected by the learner.

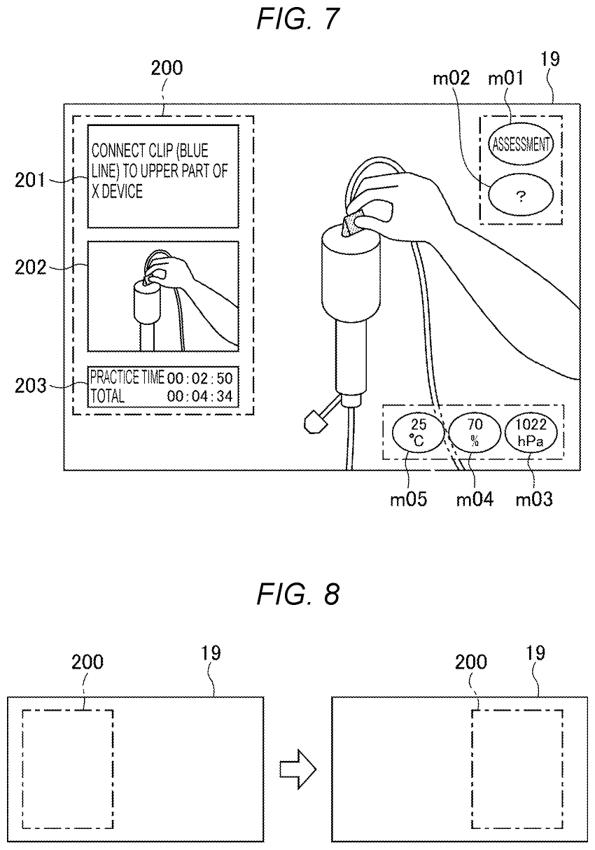

FIG. 7 is a schematic diagram of an example of the learning program displayed on the learner terminal 1 according to the embodiment of the present invention. As illustrated in FIG. 7, the content displayed in the display area 200 of the display screen 19 includes, for example, a practice instruction text display area 201, a practice instruction image/moving image display area 202, and a time display area 203. In the practice instruction text display area 201, character information necessary for a practice of operating the medical device is displayed. Note that the learning program to be output by voice is preferably matched with the text displayed in the practice instruction text display area 201. As a result, the learner can hear the character information displayed and the voice information output by voice without confusion. Furthermore, the learning program to be output by voice may not match the text displayed in the practice instruction text display area 201. As a result, it is possible to shorten the time related to the execution of the practice of the learning item.

In the practice instruction image/moving image display area 202, a moving image and an image necessary for the operation are displayed. The moving image displayed in the practice instruction image/moving image display area 202 can be paused or viewed again by input of a voice, a motion, or the like of the learner. In the time display area 203, the practice time during which the practice was performed on the displayed learning item and the total of the practice time of the entire learning program are displayed. That is, the learner terminal 1 may include a clock that manages clock time or an internal timer having a clocking function. By displaying the clock time acquired from the internal timer, the learner can confirm the clock time. Furthermore, by displaying the time to be clocked using the internal timer, the learner can manage the practice time, the learning time, and the like. At this time, it is not necessary to always display the clock time or the like, and the clock time or the like may be displayed at a timing requested by a voice or the like of the learner.

The content displayed in the display area 200 can be arbitrarily switched by input of a voice, a motion, or the like of the learner. Furthermore, the content displayed in the display area 200 has transparency, and the learner can continue the practice of operating the medical device while comparing his/her own practice with the displayed instruction content. Furthermore, on the display screen 19, with respect to the device that the learner is practicing operation, a marker may be displayed to be superimposed on a part that is important for performing the operation of the practice, or a guideline for assisting the operation of the practice may be displayed to be superimposed.

In the learning program according to the embodiment of the present invention, processing associated with voice information of a voice uttered by a learner and motion image information can be performed. For example, when “OK” is uttered by voice, the next learning item is displayed. When “Back” is uttered, the processing returns to the previous learning item. Furthermore, when “Once more” is uttered, the same learning item is displayed. Furthermore, processing associated with sound information generated by a motion of the learner may be performed. For example, it is possible to acquire a sound generated by a finger snapping motion or a hand clapping motion and perform processing associated with the sound.

Here, the motion image is an image related to a motion of the learner, such as a hand swing or blinking of the learner. For example, it is possible to use the movement of the head of the learner acquired by the acceleration sensor, use the movement of the body of the learner such as finger shaking, use the movement of the eyes of the learner, and the like. Specifically, in a case where eye movement is used, the number or the like of blinks of the learner is acquired, and when blinking is performed a predetermined number of times, processing corresponding thereto is executed. Furthermore, in a case where a line-of-sight switch is used, when the learner views a predetermined icon or the like for a certain period of time or more, the processing corresponding to the icon is executed.

In the input from the learner related to the transmission of the learning program, the transmission of the learning program transmission request and the selection of the learning item can be performed by using the voice and the motion image. As a result, it is possible to transmit the learning program transmission request without interrupting the operation manually performed by the learner. In step S20, although the voice or the motion image is acquired, the learning program transmission request may be transmitted or the learning item may be selected by operating an operation button or the like. Furthermore, the learning program and the learning item played by the learner terminal 1 can be changed by an operation from the leader terminal 4.

In FIG. 7, a mark m01 is a display by which it can be confirmed whether an “assessment mode” described later is activated. A mark m02 is a display by which it can be confirmed whether a “help mode” described later is being activated. The marks m01 and m02 are displayed in different colors between before and during activation of each mode. As a result, the learner can easily confirm whether each mode has been activated.

The “help mode” is a mode for requesting a more detailed practice instruction in a case where the learner cannot understand a practice such as an operation of a device only by learning items played. The voice acquisition unit 111 of the learner terminal 1 acquires the voice “Help” uttered by the learner, whereby the “help mode” is activated. The learning item can also be data provided in the “help mode”. In the help mode, the server device 2 can store, as the learning item, information to be provided in a case where a more detailed practice instruction such as operation and mounting of the device is requested. For example, even in a case where the practice instruction information such as the operation method and the attachment explanation method displayed in the normal processing is a simple explanation using a still image or the like, the practice instruction information displayed in the help mode can be a more detailed explanation using a moving image or the like. As a result, the learner who cannot understand only from the normal practice instruction can receive a more detailed practice instruction in the help mode. For example, in the help mode, it is possible to visually confirm accurate assembly and start to end of the operation method by a continuous moving image.

A mark m03 is a display part for temperature. A mark m04 is a display part for humidity. A mark m05 is a display part for atmospheric pressure. Values measured by the sensors 114a to 114c are displayed as the marks m03 to m05. The temperature of the surrounding environment of the learner terminal 1 is measured by the temperature sensor 114a. The humidity of the surrounding environment of the learner terminal 1 is measured by the humidity sensor 114b. The atmospheric pressure of the surrounding environment of the learner terminal 1 is measured by the atmospheric pressure sensor 114c. Values such as temperature, humidity, and atmospheric pressure may be required for operation and mounting of the device. Specifically, since a medical device such as a ventilator causes gas to flow into a thin tube at a high speed, temperature, humidity, and atmospheric pressure affect the expansion rate of the gas and the flow of the gas. In addition, in maintenance management such as repair, inspection maintenance, and accuracy control of the device, it is important to grasp temperature, humidity, atmospheric pressure, and the like. Specifically, a material such as metal is deteriorated due to the influence of temperature and humidity, and deformation and distortion may occur. Therefore, by displaying the values measured by the temperature sensor 114a, the humidity sensor 114b, the atmospheric pressure sensor 114c, and the like on the display screen 19 so that the learner can confirm the values, it is possible to learn an operation or the like of a device closer to an actual practice.

In addition, in the extraction of the learning program in step S23, the learning program may be extracted on the basis of the information of the surrounding environment of the learner terminal 1 acquired by each sensor. As the information of the surrounding environment, in addition to the information by each sensor, surrounding sound acquired from the voice acquisition unit 111, surrounding brightness, vibration, and the like acquired from the imaging unit 112 may be acquired. For example, it is possible to determine whether the learner is indoor or outdoor from the acquired information on the surrounding environment and execute the learning program according to the situation. In a case where the learner is outdoor, problems such as limited types of available devices are likely to occur, and thus, it is possible to learn how to cope with such a case. For example, learning with a simulated situation under a disaster can be performed. Furthermore, it is also possible to determine whether the learner is in Japan or overseas and execute the learning program in accordance with the regulations of the country to which the learner belongs. In an educational site such as a school, a learning program with many basic explanations is executed, and in an actual medical site, basic explanations are reduced and explanations regarding operations are increased so that it is possible to provide a more practical learning program.

FIG. 8 is a schematic diagram illustrating an example of the display screen 19 of the learner terminal 1 according to the embodiment of the present invention. The display area 200 exists in a part of the display screen 19. The learner terminal 1 can move the position of the display area 200 according to an instruction from the learner. As a result, it is possible to display information at a preferable display position according to the learner or the content of the practice. For example, in a case where the learner is right-handed and there is an operation target device on the right side, the displayed information is less likely to interfere with the task when the display area 200 is located on the left side. On the other hand, in a case where the learner is left-handed and there is an operation target device on the left side, the displayed information is less likely to in interfere with the task when the display area 200 is located on the right side. The display area 200 only needs to be present inside the display screen 19, and its size and position are not limited.

Here, the information may be displayed on the display screen 19 so that the information can be visually recognized at least with one eye of the learner. The learner terminal 1, which is a wearable terminal, is worn by a learner who is executing a practice. Thus, displaying information to be visually recognized with both eyes may hinder the practice of the learner. In addition, displaying the information to be visually recognized with both eyes may cause the brain to be confused. Therefore, by displaying the information only for one eye during transfer or practice, surrounding environment information can be visually recognized by the other eye. Conversely, the learner can concentrate on the learning program by displaying the information for both eyes when the learner is in a stationary state or if so desired by the learner. In addition, the display area 200 is preferably located at a position other than the center of the field of view of the learner. As a result, it is possible to prevent the display of information by the display area 200 from interfering with the practice of the learner.

### [Learning Program Execution Processing]

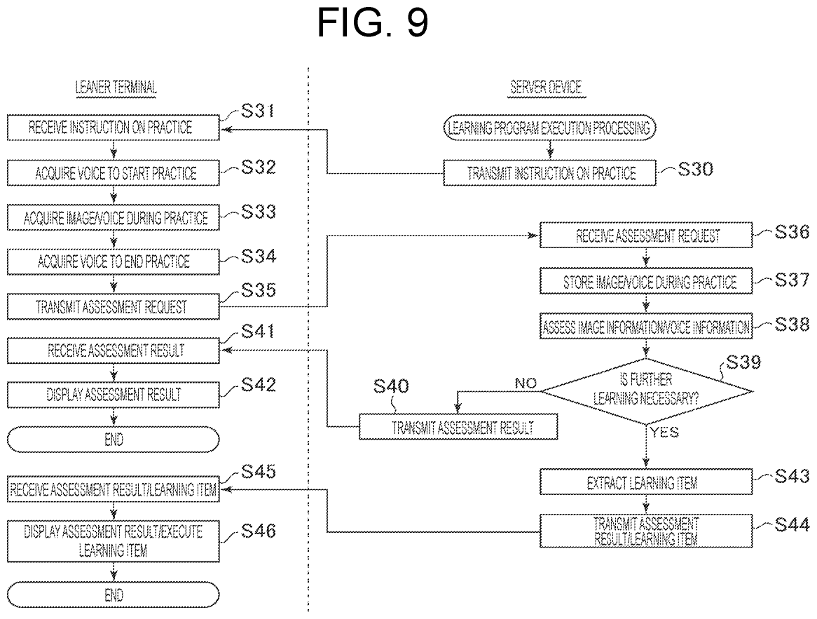

Next, the learning program execution processing will be described. FIG. 9 is a diagram illustrating a flowchart of the learning program execution processing according to the embodiment of the present invention. First, the server device 2 transmits an instruction on a practice to the learner terminal 1 (step S30), and receives the instruction on the practice in the learner terminal 1 (step S31). In the learner terminal 1, the voice acquisition unit 111 acquires a voice to start the practice uttered by the learner (step S32). The practice may be started by acquiring a specific motion image of the learner. In the learner terminal 1, the imaging unit 112 and/or the voice acquisition unit 111 acquires an image and/or a voice during the practice (step S33). It is preferable that the image and/or the voice during the practice be acquired once or more in the learning item that needs to be assessed between the start and the end of the practice. In the case of a learning program including a plurality of learning items, it is preferable to acquire an image and/or a voice during the practice in each of the plurality of learning items that need to be assessed from the start to the end of the practice. Furthermore, a moving image from the start of the practice to the end of the practice may be acquired.

In the learner terminal 1, when the voice acquisition unit 111 acquires a voice to end the practice from the learner (step S34), an assessment request is transmitted from the learner terminal 1 to the server device 2 (step S35). The end of the practice may be performed by acquiring a specific motion image of the learner. The assessment request includes image information and/or voice information during the practice. The server device 2 receives the assessment request (step S36), and the image information and/or the voice information during the practice is stored in storage means such as a RAM and a storage unit of the server device 2 (step S37). The server device 2 analyzes the stored image information and/or voice information during the practice, and assesses the practice (step S38). As a result of the assessment, when it is determined that further learning is necessary (Yes in step S39), the process proceeds to step S43. When it is determined that further learning is not necessary as a result of the practice (No in step S39), the process proceeds to step S40.

The assessment of the learner's practice in step S38 will be described. Regarding the practice of the learner, it is possible to assess whether the practice has been performed without any problem for a single learning item or whether the practice is performed without any problem through the entire practice. In the embodiment of the present invention, since the image information, the voice information, and the moving image information regarding the practice of the learner are recorded, objective assessment by artificial intelligence, a leader, and/or the learner can be performed using these pieces of information. The objective assessment is not particularly limited, but for example, the attainment, the comprehension, execution time, the skill level, achievement time, the practice time of the learning items, a timing of operation, perfection, a shape, accuracy of the practice, and the like are used.

In a case where assessment is performed using the image information, image information during the practice is compared with image information for determination registered in advance for each learning item for which assessment is necessary. These determinations are made by artificial intelligence. The image information for determination is, for example, image information or the like of a pattern in an ideal state in which the device is accurately attached in the case of a method of using the medical device. In addition, image information in a wrong state may be included. For example, image information in a case where an operation or work to be performed in a practice is appropriately performed and image information in a case where the operation or work is not appropriately performed are registered in advance, and a score is set for each piece of image information. Depending on which feature amount of image information registered in advance the feature amount of the image information obtained by the learner executing the practice matches or is similar to, a score corresponding to the matching or similar image information can be assigned as a score by the practice of the learner. Accordingly, more accurate determination can be made.

Furthermore, for a single learning item, the practice may be assessed using a plurality of pieces of image information for determination. For example, in a learning item including an A procedure, a B procedure, and a C procedure, a comparison is made to confirm whether the image information acquired during the practice includes an image of the A procedure performed, an image of the B procedure performed, and an image of the C procedure performed in the correct order. As a result, it is possible to confirm whether the learner is conducting the practice in the order of the A procedure, the B procedure, and the C procedure.

Preferably, the assessment of the practice using the image information is performed on all the learning items that need to be assessed, and a score is given to each learning item. The score for each learning item can be set as appropriate, but the score can be set according to a difficulty level and an importance level of the learning item. In a case where the learning program includes a plurality of learning items, a score obtained by summing scores of the plurality of learning items is a score of the learning program.

When the assessment is performed using moving image information, the assessment can be performed by the same method as described above. For each learning item that needs to be assessed, moving image information during the practice is compared with image information for determination registered in advance for each learning item. An image having the same scene as the image information for determination is detected from the moving image information. The above determination is made on the detected image. These determinations are made by artificial intelligence. In a case where the execution of the practice by the learner is assessed in a plurality of scenes, the determination may be performed by detecting a plurality of images of necessary scenes from the moving image information.

Furthermore, in a case where assessment is performed using voice information, assessment is performed by confirming whether a correct choice can be selected from a plurality of choices displayed on the display screen or output by voice. Furthermore, it is also possible to acquire the number of times of utterance of words reminiscent of mistakes or failures of the learner through the entire practice and take the number into account in the assessment. For example, voice information such as “Oh no” or “Failed” may be acquired, and the assessment of the learner may be lowered according to the number of times of such utterance. Furthermore, in general, it is known that when a person is disturbed, his or her voice has a frequency and sound quality different from the frequency of his or her normal voice. By analyzing the voice information such as the frequency and sound quality of the voice and the range of intonation of the uttered voice, it is possible to determine the agitation, fatigue, emotion, and the like of the learner. Therefore, the voice information of the entire practice may be analyzed to acquire a voice larger or smaller than a predetermined magnitude (also referred to as intonation) and sound quality, frequency, and the like different from normal, and the assessment of the learner may be lowered according to the number of times and the length of time for which the sound quality or frequency different from normal is given. For example, the frequency of the voice at the normal time may be registered in advance, voice information of a frequency different from a predetermined frequency may be acquired, and the assessment of the learner may be lowered according to the number of times and the length of time for uttering such a voice. Furthermore, for example, the average value of the frequencies of the voice of the learner may be calculated through the entire practice, and it may be determined in step S39 that further learning is necessary for a learning item for which the number of times greatly deviates from the average value or the time is long.

In the assessment of the practice described above, determination is made for each learning item that needs to be assessed, and as a result, a certain score is given to each learning item according to the state or result of the practice. The score may be changed according to the difficulty level or importance level of the learning item. Furthermore, as a result of the determination, in a case where the state or result of the practice has any problem, a score may not be given to the corresponding learning item, or a certain score may be subtracted from the score of the entire learning program. Furthermore, for example, in a case where the assessment of the learner is lowered according to the number of times of utterance of words reminiscent of a mistake or failure of the learner, one point may be subtracted from the overall score for each time.

The assessment of the practice of the learner can be assessed in the items of the attainment, the comprehension, the execution time, and the skill level, for example. The attainment indicates whether the execution of the learning program for a certain learning object has been completed. Specifically, in the case of a learning program related to the operation of the medical device, when the learning program is executed one or more times, the attainment of the learning program is determined to be 100%. In a case where the learning program includes a plurality of related learning items, the attainment may be set to 100% by completing the execution of all the learning items. For example, in a case of a learning program including a plurality of learning items, a score is assigned to each learning item, and a value obtained by dividing a total of scores of the learning items performed by the learner by a total of scores of all the learning items can be set as the attainment. This score is a score given according to the execution of the practice.

The comprehension indicates whether the learner can understand a certain learning object. Specifically, in a case where a certain score can be acquired as a result of executing the learning program for a certain learning object, the comprehension is determined to be 100%. For example, in a case where the learner is caused to execute a practice for each learning item and scores are given according to the execution result, a value obtained by dividing the total of the scores acquired by the learner by executing all the learning items by the total of the scores in a case where the highest points are acquired for all the learning items can be set as the comprehension.

The execution time indicates a time required to execute a practice of a certain learning program, and whether the learning program has been completed within a time is assessed. Specifically, in a case where the learning program is executed for a certain learning object and the execution of the practice can be ended within a predetermined end time, the assessment of the execution time is determined to be 100%. As the execution time, the practice time for each learning item may be assessed. In the case of referring to the practice time of the learning item, whether a single learning item has been completed within a time is assessed. Assessment may be performed for all the learning items included in the learning program as to whether the learning items have been completed within a time, or the assessment may be performed for a specific learning item. A score may be given to a learning item that ended within a time, or a score may be subtracted according to an excess time. In the assessment of the execution time, for example, in a case where the learner is caused to execute a practice for each learning item and a score is given according to the time of the execution, a value divided by the sum of scores in a case where the highest points are acquired for all the learning items can be used as the assessment of the execution time. The execution time may be a time from a sign of the start of the learner's practice to a sign of the end of the practice.

The skill level indicates whether the learning program can be executed without any problem for a certain learning object. Specifically, as a result of executing the learning program for a certain learning object, in a case where the comprehension has reached a certain level and the execution of the practice was completed within a certain time (also referred to as assessment of the execution time having reached a predetermined value), the skill level is determined to be 100%. For example, the ratio between the comprehension and the execution time can be set as appropriate, but in a case where the skill level is calculated at a ratio of the comprehension and the execution time of 2:3, the skill level is 88% in a case where the comprehension is 100% and the execution time is 80%. Note that, when the learning program was terminated halfway, the skill level is not calculated. Furthermore, in addition to the above, the skill level may be calculated by comprehensively assessing pitch, inclination, shaking, vibration, a change in the shape of a subject of the practice conducted, and the like acquired with the learner terminal 1. Furthermore, the time taken until the skill level reached 100% may be added to the assessment of the learner as the achievement time.

The assessment of the practice by the learner can be further assessed in terms of a timing of operation, perfection, shape, accuracy of the practice, and the like. Regarding the timing of operation, whether the practice has been performed in the correct order and satisfied a predetermined condition are assessed. For example, in the learning item including the A procedure and the B procedure, the B procedure is performed within a predetermined time (for example, within 5 seconds) after it is confirmed that the measurement value of an X device during the A procedure has reached a predetermined value. In this case, it is confirmed whether the image of the A procedure performed and the image of the B procedure performed are included in the acquired image information during the practice in the correct order, and whether the B procedure was performed within 5 seconds after the measurement value of the X device reached the predetermined value. If the practice is performed in the correct order and satisfies a predetermined condition, a score corresponding to the difficulty level, importance level, or the like of the timing of the operation may be given. Furthermore, in a case where the practice is performed in the correct order but does not satisfy a predetermined condition, it may be determined that further learning is necessary for the corresponding learning item or learning program.

The perfection indicates the degree of finished quality of the shape or the like of the learning object. For example, in the case of a learning program for bed making, the wrinkle shape on a bed sheet, the positions of pillows, and the like after a practice are confirmed. A completed image and an uncompleted image are registered in advance, and a score is set for each piece of image information. Depending on which feature amount of image information registered in advance the feature amount of the image information obtained after the practice matches or is similar to, a score corresponding to the matching or similar image information can be assigned as a score by the practice of the learner. Furthermore, the perfection may be calculated by a matching or similar rate to the completed image. It is preferable that a large number of completed images and a large number of uncompleted images be stored in images stored as teacher data. Accordingly, more accurate assessment can be made. In a case where the learning program includes a plurality of learning items, the perfection may be calculated for each learning item.

The accuracy of a practice indicates the accuracy of the state or result of the practice by the learner. Specifically, a degree of matching between the image information of the state or result of the practice by the learner and an image for determination is calculated. Not only the image information but also parameters (pitch, vibration, inclination, speed, and the like) necessary for assessment may be registered in advance, and the parameters may be detected from the acquired image information and moving image information. In the accuracy of the practice, for the execution of the practice by the learner, a distance from the subject, an interval, an angle, speed of the operation, a part subjected to operation, and the like are detected and assessed. For example, in the case of a learning program of a blood sampling method, a part to be disinfected, an angle, speed, and a part of piercing a needle, positions of the hands of the learner, and the like are extracted from the image information and the moving image information. The image information for determination registered in advance is compared with the image information when the learner conducted the practice, and if a determination target is within a predetermined range, the accuracy of the practice may be set to 100%, or the assessment may be lowered such as subtracting a score depending on how much the deviation from a predetermined range is.

The above assessment of the learner's practice can be performed by artificial intelligence. As a result, since the practice is objectively assessed, fair assessment can be performed. Furthermore, the assessment of the practice of the learner may be performed by the leader and/or the learner on the basis of the recorded image information, voice information, and moving image information regarding the practice of the learner, or may be performed by combining the assessment by the leader and/or the learner and the assessment by artificial intelligence.

Note that, in the learning program execution processing described above, assessment is performed on the practice of the learner after the series of learning items is completed. However, the assessment may be performed on the practice for each learning item, and the processing may proceed to the next learning item when the result of the practice has no problem. In this case, it is also possible to calculate the overall score by adding or subtracting a score corresponding to the assessment result each time the learning item is completed.

The transmission of the assessment request in step S35 may be performed by activation of the “assessment mode”. The “assessment mode” can be performed in the middle of the practice of the learning program regardless of the processes of steps S30 and S31. As a result, for example, in a case where the learner who performs the learning item for attaching the device does not have confidence in his/her practice result, it is possible to confirm whether the practice result is correct or incorrect on the spot. Note that, in a case where the “assessment mode” is activated in the middle of the learning program, the score regarding the learning item may not be included in the score regarding the entire assessment, or a certain score may be excluded from the score regarding the entire assessment.

As a result of the assessment in step S38, in a case where it is determined that further learning is not necessary in step S39, the assessment result is transmitted from the server device 2 to the learner terminal 1 (step S40), and the assessment result is received in the learner terminal 1 (step S41). The assessment result is displayed on the learner terminal 1 (step S42). The assessment result is displayed as character information or image information on the display screen 19. Furthermore, the assessment result may be output by voice from the voice output unit 113.

As a result of the assessment in step S38, in a case where it is determined that further learning is necessary in step S39, the server device 2 extracts a learning item (step S43). The extracted learning item is based on the assessment result. For example, as a result of the determination, a learning item to which no score is given or a learning item from which a score is subtracted can be extracted. Furthermore, not only the learning item to which no score is given or the learning item from which a score is subtracted, but also learning items related thereto may be extracted. Furthermore, in a case where the overall score is equal to or less than a certain level, it is also possible to extract the entire learning program. Furthermore, in a case where the comprehension of the learner is equal to or less than a certain level, it is also possible to extract a learning program suitable for the learner. For example, it is possible to extract a learning program with more detailed explanations or a learning program having much image/moving image information.

The determination as to whether further learning is necessary in step S39 can be set as appropriate according to the assessment in step S38. For example, the determination that further learning is not necessary includes the assessment item of the attainment, the comprehension, the execution time, and/or the skill level being equal to or greater than a certain value, an essential learning item being executed, the score of the assessment of the practice using the image information being equal to or greater than a certain score in a specific learning item, the score of the entire learning program being equal to or greater than a certain score, and the like. For example, the determination that further learning is necessary includes the assessment item of the attainment, the comprehension, the execution time, and/or the skill level being equal to or less than a certain value, an essential learning item being not performed, the score of assessment of the practice using the image information being equal to or less than a certain score in a specific learning item, the score of the entire learning program being equal to or less than a certain score, an operation or work irrelevant to the execution being performed during the execution of the practice, the execution of the practice being terminated in the middle, and the like. The determination as to whether further learning is necessary may further use assessment of a timing of operation, perfection, shape, accuracy of practice, and the like.

The server device 2 transmits the assessment result and the extracted learning item to the learner terminal 1 (step S44), and the learner terminal 1 receives the assessment result and the extracted learning item (step S45). In the learner terminal 1, the assessment result is displayed, and the extracted learning item is executed (step S46). In the execution of the learning item, the extracted learning item may be forcibly executed, or the learner may select a learning item to be reviewed and execute the selected learning item. Note that, in a case where a plurality of extracted learning items is included, the extracted learning items can be executed by being selected by the learner.

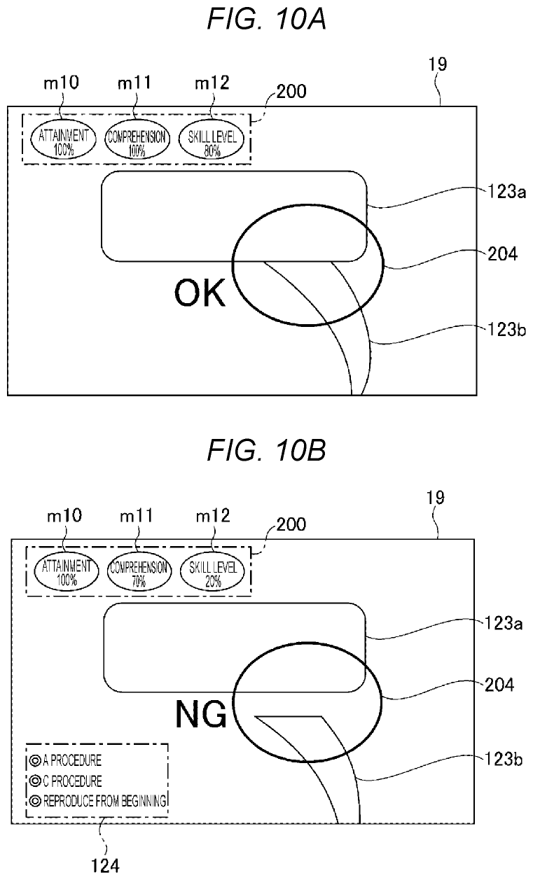

FIGS. 10A and 10B are schematic diagrams illustrating an example of the assessment result displayed on the learner terminal 1 according to the embodiment of the present invention, illustrating examples of the display screen 19 of the learner terminal 1 when the result of the practice by the learner is assessed for a learning item regarding attachment of the device.

FIG. 10A is a schematic diagram of a display result when it is determined that there is no problem as a result of assessing the image information. In the display area 200 of the display screen 19, the attainment, the comprehension, and the skill level of the learner regarding the executed learning program are displayed. The mark m10 displays the rate of the attainment, the mark m11 displays the rate of the comprehension, and the mark m12 displays the rate of the skill level. The learner can visually recognize medical device portions 123a and 123b through the display screen 19. As a result of the practice, in a case where the medical device portions 123a and 123b are attached without any problem, a determination result 204 is displayed on the display screen 19. For example, on the display screen 19, a connection portion between the medical device portion 123a and the medical device portion 123b may be circled so that the connection between the medical device portion 123a and the medical device portion 123b can be visually recognized by the learner, and “OK” may be displayed.

FIG. 10B is a schematic diagram of a display result when it is determined that there is a problem as a result of assessing the image information. In the display area 200 of the display screen 19, the attainment, the comprehension, and the skill level of the learner regarding the above-described executed learning program are displayed. In a case where the medical device portions 123a and 123b are not attached as a result of the practice, a determination result 204 is displayed. For example, on the display screen 19, a connection portion between the medical device portion 123a and the medical device portion 123b may be circled so that the learner can visually recognize that the medical device portions 123a and 123b are not connected, and “NG” may be displayed. Furthermore, a learning item 124 extracted by the server device 2 is displayed on the display screen 19. The necessity to execute the extracted learning item may be output from the voice output unit 113 to alert the learner or may be displayed on the display screen 19. The learner can select a learning item to be learned from the displayed learning items 124 and execute the selected learning item. Furthermore, a learning item that is not displayed can be selected.

The assessment of the practice in step S38 may be transmitted not only to the learner terminal 1 but also to the leader terminal 4, and the assessment information of the learner may be stored in the leader terminal 4. As a result, the leader can grasp the learning progress of the learner. Furthermore, since the practice of the learner is assessed by artificial intelligence, it is possible to perform fair assessment without applying any bias held by the leader to the learner.

The image information and/or the voice information during the practice recorded in step S37 can be played at an arbitrary timing in the learner terminal 1 and the leader terminal 4. As a result, the learner can review his/her own practice after the execution of the learning program with reference to the recorded image information and/or voice information during the practice. Since it is possible to look back on the practice that he/she has conducted from his/her own viewpoint, it is possible to effectively recall memories during the practice, and it is possible to comprehensively improve learning efficiency. Furthermore, the leader can provide detailed assessment that cannot be determined by artificial intelligence in the learner's practice.

The image information and/or the voice information during the practice may be stored in the server device 2 at an arbitrary timing of the learner. For example, when the learner utters a voice such as “Record”, the server device 2 is caused to store the image information during the practice acquired by the built-in camera, the voice information acquired by a microphone inside and outside the glasses of the learner terminal 2, and/or the information displayed on the display screen 19. At this time, the stored clock time may be associated and stored. By storing the clock time together with an image, a voice, or the like, it is possible to confirm which practice the stored value corresponds to.

Although the description has been mainly given assuming the operation method of the medical device, the learning system of the present invention is not limited thereto, and can be used for other learning. For example, the method can be a method of performing manipulation or a technique such as how to wind a bandage, how to perform bed making, and a method of performing intravenous drip injection. Furthermore, the learning system of the present invention can be utilized in education in various fields such as cooking training, beauty training, trimmer training, and tool handling. Furthermore, for example, the learning system of the present invention can also be used for learning in which cases are displayed on the display screen 19 of the learner terminal 1 and the learner is caused to answer a question such as “In this case, how do we deal with them?”.

Furthermore, the learner terminal 1 and the leader terminal 4 can be communicably connected to each other. As a result, for example, even in a case where there is no leader at a place where the learner practices, the image/moving image information and the voice information regarding the execution by the learner can be transferred to the leader terminal 4, and advice can be obtained from the leader in real time. At this time, the leader can confirm the image/moving image information and the voice information transmitted from the learner terminal 1, superimpose his/her hand or a marker on the image/moving image information on the learner terminal 1 to be displayed on the display screen 19 of the learner terminal 1. Furthermore, the advice from the leader may be displayed as character information, or the voice of the leader may be output from the learner terminal 1. As a result, the learner can understand the advice from the leader without misrecognizing the advice. In addition, it is possible to transfer the image/moving image information and the voice information related to the execution from the leader terminal 4 to the learner terminal 1 and present a good example of the execution to the learner. Since the leader terminal 4 can also be communicably connected to a plurality of learner terminals 1, information from the leader can be efficiently presented to the learners in an education site where a plurality of learners exists. Furthermore, in a case where the leader uses a wearable terminal similar to the learner terminal 1, the learner can view the image information along the line of sight of the leader, so that the learner can conduct the practice with good reproducibility.

### EXAMPLES

Reference Example 1 and Reference Example 2 of the present invention will be described below, but the present invention is not limited thereto in any sense.

### Reference Example 1

A learning system according to the embodiment of the present invention was used for learning the assembly and priming of a hemodialysis circuit. The assembly and priming of the hemodialysis circuit includes learning items such as article preparation, assembly, and final inspection.

Learning items are displayed on the wearable terminal worn by the learner. Specifically, the learning items each include a text and an image related to the operation content. Furthermore, the learner can select the display screen and the preceding and following learning items by uttering a voice “OK/NG/One more time/Return to the previous step”.

### (Configuration of Learning System)

As the learning system, a system including a glasses-type wearable terminal, a controller, a wireless headset, and a computer device was used. As the glasses-type wearable terminal, smart glasses having a screen resolution of 1280×720 and RGB was used. The glasses-type wearable terminal has the above-described display function. Furthermore, a Bluetooth headset having the above-described voice acquisition function and voice output function was used.

In addition, a controller having a voice recognition function was used. For the control of the display screen by the recognized voice, improved on-site work support solution software incorporated in the computer device was used. In the creation of the learning program, photographs of parts necessary for screen display and for each priming step were taken, guidance content in the step was represented as a character string, and operation instruction (learning items) data of the practice was created. The display order of the learning items was determined according to the steps, and the learning items were input to an Excel file for manual creation in the on-site work support solution software and programmed. The learning items used had 37 steps.

The subject persons of learning were 9 persons who had not yet assembled a hemodialysis circuit. Assessment persons were 10 persons who had already learned the assembly and the priming method of a hemodialysis circuit.

Using the learning system configured as described above, a learning program related to the assembly and priming operation of a hemodialysis circuit was executed for practices according to the flowchart in FIG. 6 and in steps S30 and S31 FIG. 9. Thereafter, practices by the learning program were conducted five times every other week. Immediately after the fifth practice, a practice was performed without using the learning program. One month later, another practice was performed without using the learning program, and assessment items were scored. For the assessment of learning effects, a give-up rate, a completion point, and a time required for the entire practice were used.

### (Give-Up Rate)

The number of subject persons who determined they were not able to complete the work and declared give-up was divided by the number of subject persons to obtain the give-up rate. In addition, the experiment results of give-up persons were excluded from the determination of the completion point and the required time.

### (Completion Point)

The completion point was done by the assessment person's scoring. After the assembly was completed, the assessment person performed assessment according to a table of the completion points, and the maximum score was set to 15 points.

### Reference Example 2

The operation of the learning item displayed on the glasses-type wearable was changed not to the voice input by the utterance of the learner but to the manual input (a third person switches the screen by the sign of the learner). Furthermore, the learning items used had 42 steps. In addition, in the execution of the practice by the learning program, a practice was first conducted, and then practices were conducted twice every two weeks. Two months later, an operation was performed without using the learning program, and assessment items were scored. The learning system of Reference Example 2 does not have a voice recognition function, a voice acquisition function, and a voice output function. As to other matters, the learning system that is the same as the one in Reference Example 1 was used.

The subject persons of learning were 18 persons who had not yet assembled a hemodialysis circuit. Assessment persons were 5 persons who had already learned the assembly and the priming method of a hemodialysis circuit.

In Reference Example 2, the maximum score of the completion point was set to 10 points.

### [Results]

Comparing the results of Reference Example 2 and Reference Example 1, the give-up rate was 6/18 (33%):1/9 (11%), the completion point was 8.6/10 (86%):13.6/15 (91%), and the required time was 18.3 minutes:17.3 minutes. The give-up rate decreased, and the completion point and the required time were improved.

As is apparent from the above, with the learning system according to the present invention, it is possible to provide an effective learning method for a learner.

### REFERENCE SIGNS LIST

1, 1a, 1b, 1z Learner terminal
2 Server device
3 Communication network
4 Leader terminal
11 Control unit
12 RAM
13 Storage unit
14 Graphics processing unit
15 Communication interface
16 Interface unit
17 External memory
18 Display unit
19 Display screen
21 Control unit
22 RAM
23 Storage unit
24 Communication interface
111 Voice acquisition unit
112 Imaging unit
113 Voice output unit
114 Sensor unit
114a Temperature sensor
114b Humidity sensor
114c Atmospheric pressure sensor
121a, 121b, 121c Medical device
122a, 122b, 122c Learning program
123a, 123b Medical device portion
124 Learning item
200 Display area
201 Practice instruction text display area
202 Practice instruction image/moving image display area
203 Time display area
204 Determination result

1. A learning system that includes at least a wearable terminal to be worn by a learner and is directed to learning of a learning object through a practice, the learning system comprising:
a learning program executer that executes a learning program that prompts a learner to conduct a practice for learning about a learning object; and
a practice information acquisitor that acquires image information and/or voice information regarding a state or a result of the practice by the learner during execution of the learning program by an imaging function and/or a voice acquisition function provided in the wearable terminal.

2. The learning system according to claim 1, further comprising:
an assessor that assesses the state or the result of the practice by the learner based on the image information or the voice information regarding the acquired state or result of the practice.

3. The learning system according to claim 2, further comprising:
an outputter that outputs a learning item that requires further learning in accordance with a result of assessment by the assessor.

4. The learning system according to claim 1, wherein the learning object is a method of using a device or a method of executing manipulation.

5. The learning system according to claim 1, further comprising:
an input operation acquisitor that acquires image information or voice information regarding a motion of the learner during execution of the learning program by the imaging function or the voice acquisition function provided in the wearable terminal; and
an input executer that executes an input for progress of the learning program in accordance with the acquired image information or voice information regarding the motion of the learner.

6. The learning system according to claim 2, wherein the assessor assesses the state or the result of the practice by the learner based on a time from a start to an end of the practice by the learner and the image information or the voice information regarding the acquired state or result of the practice.

7. The learning system according to claim 2, wherein the assessor outputs learning attainment, comprehension of the learning object, and/or a skill level to the learning object as the state or the result of the practice by the learner.

8. The learning system according to claim 1, wherein the practice information acquisitor acquires image/moving image information regarding the state or the result of the practice, the learning system further comprising:
a player that plays the image/moving image and/or the voice based on the acquired image/moving image information and/or the voice information.

9. The learning system according to claim 1, further comprising:
an environmental information measurer that measures environmental information of a space in which the learner is learning, wherein
the learning program executer executes a learning program according to a measured environment.

10. The learning system according to claim 1, further comprising a computer device operated by a leader, wherein
the computer device is capable of communication connection with the wearable terminal worn by the learner.

11. A learning method executed in a learning system that includes at least a wearable terminal to be worn by a learner and is directed to learning of a learning object through a practice, the learning method comprising:
executing a learning program that prompts a learner to conduct a practice for learning about a learning object; and
acquiring image information and/or voice information regarding a state or a result of the practice by the learner during execution of the learning program by an imaging function and/or a voice acquisition function provided in the wearable terminal.
